(19) United States
(12) Patent Application Publication
(10) Pub. No.: US 2005/0149954 A1
(43) Pub. Date: Jul. 7, 2005

(54) Optical disk drive and casing thereof

(76) Inventors: Chao-Liang Wang, Hsinchu City (TW); Yung-Hua Su, Bade City (TW)

Correspondence Address: SUPREME PATENT SERVICES, POST OFFICE BOX 2339, SARATOGA, CA, 95070, US

(21) Appl. No.: 10/751,127

(22) Filed: Jan. 3, 2004

(51) Int. Cl. G11B 33/02

(52) U.S. Cl. 720/600

(57) ABSTRACT

An optical disc drive and a casing enclosing the optical disk drive are disclosed. The casing is a hollow and half-closed rectangular parallelepiped. A vertical end surface of the casing has an insertion opening for inserting the optical disc drive into an internal space thereof. An opposite vertical end surface of the casing is closed by a circuit board. The circuit board includes an interface connecting cable and a power supply cord respectively connected to the corresponding connection component of the optical disc drive. The casing has a bottom opening on a rear portion of the bottom thereof. A removable bottom cover openably closes the bottom opening. The optical disc drive is fixed in the internal space of the casing.

### BACKGROUND OF THE INVENTION

1. Field of the Invention

The present invention relates to an optical disc drive, and more particularly to a casing of the optical disk drive that facilitates assembly and maintenance.

2. The Related Art

An optical disc drive is a general and popular electronic product now. In general, an optical disc drive has a standard dimension specification, namely a rectangular parallelepiped. It can be provided for computer manufacturers to be installed in a computer. However, for a separated optical disc drive, it needs to be packaged by a casing depending on the manufacturer's design and thus forms the current product in market. A conventional packaging structure comprises two screwed split casings respectively having a U-shape and a reverse U-shape. In assembling, the optical disc drive is first fixedly screwed to the bottom casing. Then, the related interface connecting cables and power supply cord are connected. Finally, the top casing is fixedly screwed to the bottom casing. However, this structure has the following defects:

(1) The casings are generally made up of plastic materials. Because the casings are not provided with female threading holes, self-tapping screws are used to fix the casings together. Due to the use of self-tapping screws, once the casings are initially fixed in an improperly aligned condition, it is not possible to re-fix the casings tightly together and often the casings can be fixed in an off-position condition, leading to defective products.

(2) Using self-tapping screws to fix the casings together requires highly skilled operators.

(3) The casings must be completely disassembled before maintenance can be carried out, which is inconvenient to the general users and maintenance personnel.

### SUMMARY OF THE INVENTION

An object of the present invention is to provide with an optical disc drive having a casing that can be conveniently assembled and maintained. The casing is a hollow and half-closed rectangular parallelepiped. A vertical end surface of the casing has an insertion opening for receiving the optical disc drive into the casing. An opposite vertical end surface of the casing is closed by a circuit board. The circuit board has an interface connecting cable and a power supply cord respectively connected to the corresponding connection components of the optical disc drive. The casing has a bottom opening on a rear portion of the bottom thereof for conveniently assembling the related connections with the optical disc drive. A removable bottom cover closes the bottom opening. As a result, the assembling operation is simple and easy. Production efficiency can thus be increased and the defectives are largely reduced.

In comparison with a conventional structure, the optical disc drive and the casing thereof according to the present invention have the following advantages:

(1) It does not need to screw two casing members together as illustrated in the conventional structure. The assembling operation can thus be simplified and the production efficiency can be increased.

(2) The assembling operation can be carried out a regular operator, no particular skill being needed.

A quick check for trouble-shorting can be done by removing the bottom cover. This allows an operator or maintenance personnel to check troubles caused by disengagement or disconnections of parts. No complete disassembly of the whole unit is necessary unless serious problems occur. The present invention is easy, simple, convenient and flexible in maintenance as compared to the conventional structures.

The technical features and effectiveness of the present invention will be apparent to those skilled in the art after reading the detailed description of the preferred embodiment thereof in reference to the accompanying drawings.

### BRIEF DESCRIPTION OF THE DRAWINGS

FIG. 1 is an exploded view of an optical disc drive in accordance with the present invention; and

FIG. 2 is a perspective view of the optical disk drive of the present invention.

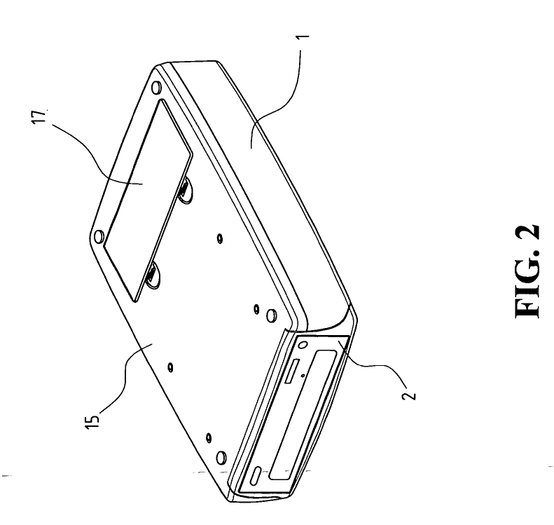

### DETAILED DESCRIPTION OF THE PREFERRED EMBODIMENT

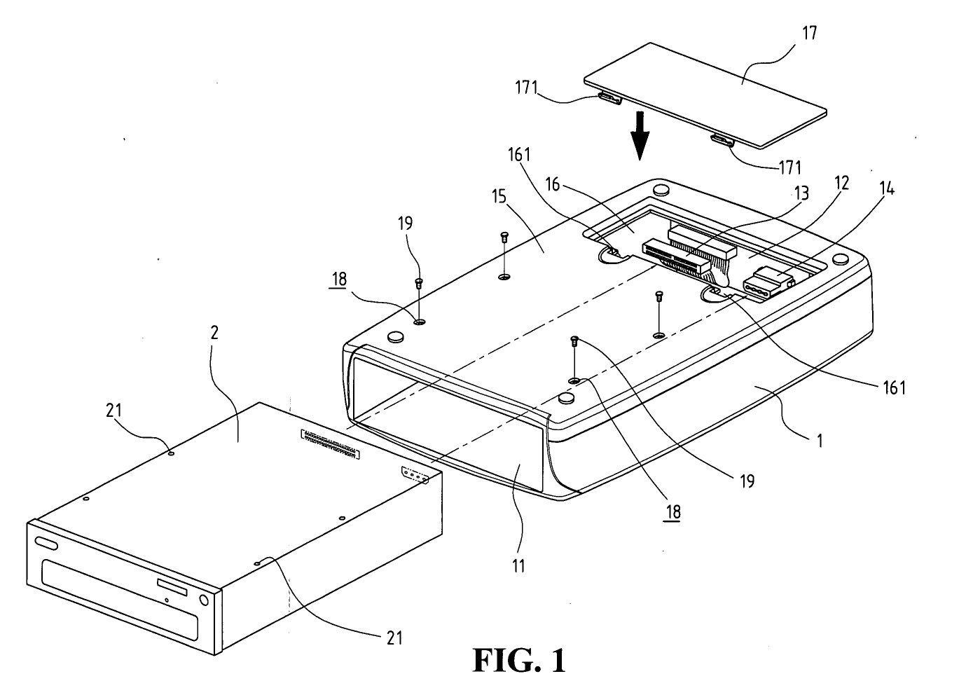

Referring to FIG. 1, which illustrates a bottom structure of the present invention, a casing 1 receives an optical disc drive 2 therein. The profile of the casing 1 can be changed depending on a manufacturer's design. The casing 1 is a hollow and half-closed rectangular parallelepiped, forming an internal space accommodating the optical disc drive 2. A vertical end surface of the casing 1 has an insertion opening 11 for the entrance of the optical disc drive 2 into the internal space of the casing 1. An opposite vertical end surface of the casing 1 is closed by a circuit board 12. The circuit board 12 comprises an interface connecting cable 13 and a power supply cord 14. The circuit board 12 has the related insertion slots on the outside thereof for connecting with the related equipments. The casing 1 has a bottom opening 16 on a rear portion of the bottom 15 thereof. A removable bottom cover 17 closes the bottom opening 16. The bottom opening 16 is provided on a side thereof with two retaining grooves 161. The bottom cover 17 has two elastic retainers 171 fixedly engaged with the two retaining grooves 161 of the bottom opening 16. The interface connecting cable 13 is located at the bottom opening 16 so as to be conveniently connected with the corresponding connection component of the optical disc drive 2. Furthermore, the bottom 15 of the casing 2 is provided on proper positions with a plurality of through holes 18 for fixedly screwed by screws 19 to screw holes 21 of the optical disc drive 2.

To assemble, the casing 1 is first turned upside down as shown in FIG. 1. The optical disc drive 2 is inserted from the insertion opening 11 into the casing 1. After aligned, the optical disc drive 2 and the casing 1 are fixed together by tightening the screws 19 through the holes 18 of the casing 1 to the screw holes 21 of the optical disc drive 2. Then, the interface connecting cable 13 and the power supply cord 14 are respectively connected to the corresponding connection components of the optical disc drive 2, and the bottom cover 17 is attached to the bottom opening 16.

The present invention has the advantages of simple assembly, needing no skilled operator and reducing fraction defectives. In addition, the removable bottom cover 17 helps for maintenance. If a defective results from an imperfect connection, a reconnection can be made through the bottom opening 16. Unlike the conventional structure that needs to be completely disassembled for maintenance, the present invention makes the assembly quick, the maintenance convenient, and fraction defective largely reduced.

The above statement is only for illustrating the preferred embodiment of the present invention, and not for giving any limitation to the scope of the present invention. It will be apparent to those skilled in this art that all equivalent modifications and changes shall fall within the scope of the appended claims and are intended to form part of this invention.

1. An optical disc drive comprising:
an optical disc drive; and
a casing, being a hollow and semi-closed rectangular parallelepiped and defining an internal space, wherein a vertical end surface of the casing has an insertion opening for inserting the optical disc drive into the internal space, an opposite vertical end surface is closed by a circuit board, which comprises an interface connecting cable and a power supply cord respectively connected to corresponding connection components of the optical disc drive; the casing having a bottom opening on a rear portion of a bottom thereof; and a removable bottom cover openably closing the bottom opening.

2. The optical disc drive as claimed in claim 1, wherein the bottom opening has two retaining grooves on a side thereof and the bottom cover has two elastic retainers fixedly engaged with the corresponding two retaining grooves.

3. The optical disc drive as claimed in claim 1, wherein the bottom of the casing is provided on proper positions with a plurality of through holes for fixedly screwed by screws to the corresponding screw holes of the optical disc drive.
